(19) United States
(12) Patent Application Publication
(10) Pub. No.: US 2014/0372583 A1
(43) Pub. Date: Dec. 18, 2014

(54) EXPANDABLE DEPARTMENTAL CLOUD SERVER SYSTEMS

(71) Applicant: Johnny Tseng, Fremont, CA (US)

(72) Inventor: Johnny Tseng, Fremont, CA (US)

(21) Appl. No.: 13/916,578

(22) Filed: Jun. 13, 2013

(51) Int. Cl. H04L 12/24

(52) U.S. Cl. CPC H04L 41/50
USPC 709/223

(57) ABSTRACT

An expandable office system is disclosed with one or more client units; a base unit (BU) having a predetermined hardware design acting as a base device to provide server operation; one or more network devices having the predetermined hardware design to operate in conjunction with the base unit to expand service to the one or more client units, the network device selected from a group consisting of: a second network unit having the predetermined hardware design coupled to the first unit and serving as a mirror unit under software configuration, wherein the second unit is added as a mirror unit (MU) to back up the first unit as a server; a third network unit having the predetermined hardware design coupled to the first unit and serving as an expansion unit (EU) under software configuration, wherein the third unit is added as needed to increase client capacity; and a fourth network unit having the predetermined hardware coupled to the first unit and located at a remote location from the first network unit, and with software configuration, acts as a remote disaster recovery (RU) unit, wherein each of the BU, MU, EU and RU shares a single physical characteristics, with software configurable personalities or roles.

### BACKGROUND

The present invention relates to a portable, easy to deploy, and expandable server for small to medium businesses.

Small and medium-sized businesses (SMBs) are often defined as those having 100 or fewer employees (for a small business) and 100-999 employees (for a medium sized business). Small and medium-sized business owners understand the difficulties and challenges when it comes to staying on top of finances and technological improvements. In order to stay ahead companies need to find business partners that can help them incorporate affordable solutions to meet their growing business needs.

Small and medium-sized companies need to understand the challenges within their marketplace and how they see this sector developing. In staying ahead of the competition these businesses need to have understanding into many areas including business software solutions, email marketing, talent management, information technology, wireless applications, technology hardware and much more. Not all solutions are a fit for every business and as such, companies need to find the right mix of solutions that will help meet their specific requirements.

The SMB market has been devoid of products that actually solve the problem of an SMB owner. Their main problems are: high cost to acquire, high cost of on-going maintenance, high complexity needing IT help. While there are many products on the market, none of them are designed so that a business owner can easily use without an IT support. The hardware and software are built around computers, thus they are bulky, unwieldy and expensive.

FIG. 1 shows a conventional office server set up. In this conventional system, routers and WiFi access points enable servers to access the Internet. Each server may be powered by an uninterruptible power supply (UPS) to protect against power outage. A file server can be provided to storage of files and handle file requests. A web server can be installed. The web server, when connected to a TCP/IP network, can receive requests for information from external web browsers. Such requests for information may be formulated as requests to view data captured during a recent, previous period of operation. The web server is coupled to a memory, so that data and files stored in the memory may be transferred to the requesting web browser. A web server is part of the user interface system. A web server and web browser connected together via a TCP/IP network form an interface system that is convenient and very powerful. Complete control of the event recorder is facilitated by prerecorded “web pages” or “web forms,” that may be designed to be part of the web server. Therefore, the requirement for proprietary software and the complexity and inconvenience associated therewith is eliminated.

Often referred to as simply “mail server”, an e-mail server is a computer within the network that works as a virtual post office. A mail server usually consists of a storage area where e-mail is stored for local users, a set of user definable rules which determine how the mail server should react to the destination of a specific message, a database of user accounts that the mail server recognizes and will deal with locally, and communications modules which are the components that actually handle the transfer of messages to and from other mail servers and email clients. Generally the person(s) responsible for the maintenance of the e-mail server (editing users, monitoring system activity) are referred to as the postmaster. The servers are typically backed-up through a backup device. During a backup operation, the backed up data (the backup) is written to a physical backup device. This physical backup device is initialized when the first backup in a media set is written to it. The backups on a set of one or more backup devices compose a single media set.

The above approach can handle a large number of employees. However, such systems require dedicated IT staff to maintain. Additionally, such systems do not easily support smart phones or tablets.

### SUMMARY

In one aspect, an expandable office system is disclosed with one or more client units; a base unit (BU) having a predetermined hardware design acting as a base device to provide server operation; one or more network devices having the predetermined hardware design to operate in conjunction with the base unit to expand service to the one or more client units, the network device selected from a group consisting of: a second network unit having the predetermined hardware design coupled to the first unit and serving as a mirror unit under software configuration, wherein the second unit is added as a mirror unit (MU) to back up the first unit as a server; a third network unit having the predetermined hardware design coupled to the first unit and serving as an expansion unit (EU) under software configuration, wherein the third unit is added as needed to increase client capacity; and a fourth network unit having the predetermined hardware coupled to the first unit and located at a remote location from the first network unit, and with software configuration, acts as a remote disaster recovery (RU) unit, wherein each of the BU, MU, EU and RU shares a single physical characteristics, with software configurable personalities or roles.

Advantages of the preferred embodiments may include one or more of the following. The system can be used without IT expertise. A small business owner or department head does not need to understand about different equipment for different purpose. Rather, he or she buys the same SKU and, through intuitive graphical user interface software, configures the unit to serve a different function and build a solution that is tailored for the business. The system offers simplified network setup and attendant savings on initial installation cost. With one device, the business can access the Internet, save files, retrieve files, share files, collaborate with co-workers, keep continuous backup of all company files or add additional storage when needed. There is no need to buy separately: Router, WiFi access point, File server, Web server, Email server, and backup device. The system offers small size, silent, use very low power and very low heat. It is attractive for small spaces. The system offers a full featured server with many built-in software features that rival high-end servers. The system also services “current” computers and “future” tablets, and works, not only with computers, laptops but also smart phones and tablets. The system provides all essential network functions for employees and connects employee computers to the internet through WiFi or wired connection. The system provides secure and private file storage space for each employee, and additionally provides sharable public space or special space for project based collaboration. A Mirroring Server feature is enabled once another unit is added, protecting the business from server failures. Thus, the system easily grows with the business to easily expand storage capacity and grow to multiple departments or groups. Low on-going maintenance cost is achieved as the user interface is simplified for administration of the servers, adding, changing and removing employee. No IT specialist is required to install, manage and replace the devices—this can be accomplished by ordinary office personnel. Software updates are handled automatically.

### BRIEF DESCRIPTION OF THE DRAWINGS

FIG. 1 shows a conventional office computing system.

FIGS. 2A-2D illustrate an expandable server that supports server requirements for a one-person business user up to a multi-department company.

FIGS. 3A-3K show exemplary user interface screens that allow software customization of a plurality of units into four distinct personalities: a base unit, a mirror unit, an expansion unit, and a disaster recovery unit.

FIG. 4 shows three different configurations from one basic device.

FIG. 5 shows an exemplary user operation process.

FIG. 6 shows in more details an exemplary user information process.

FIG. 7 shows an exemplary file resource operation process.

FIG. 8 shows an exemplary system configuration process.

FIG. 9 shows an exemplary email management process.

FIG. 10 shows a network settings process.

FIG. 11 shows a user management process.

FIG. 12 shows an exemplary process for chatting using the server device.

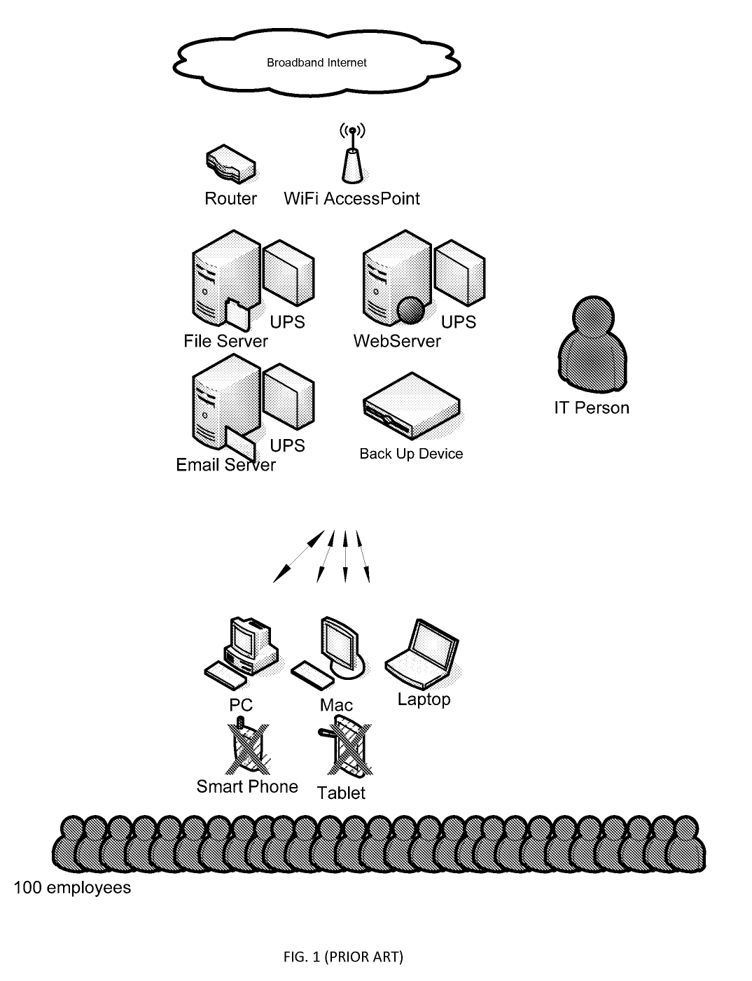

### DESCRIPTION

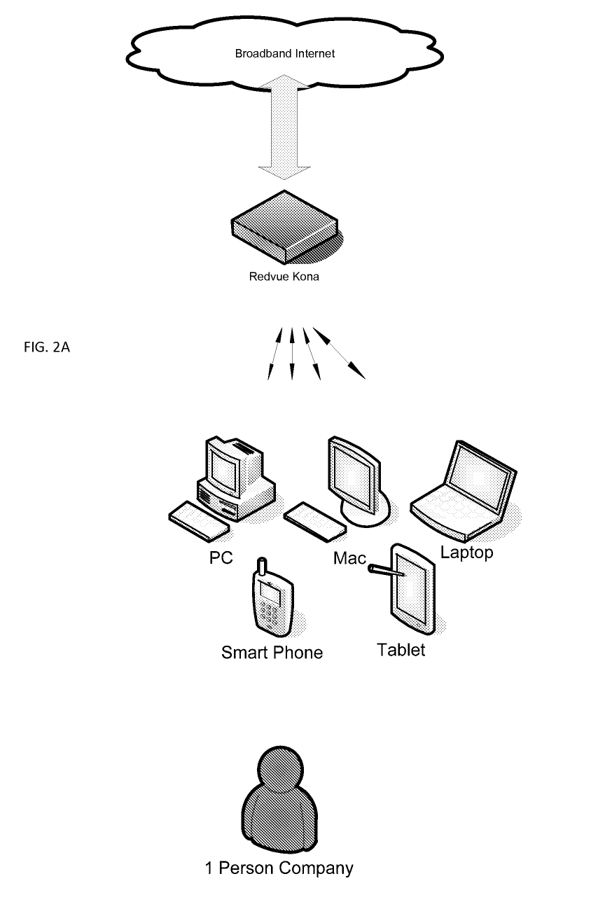

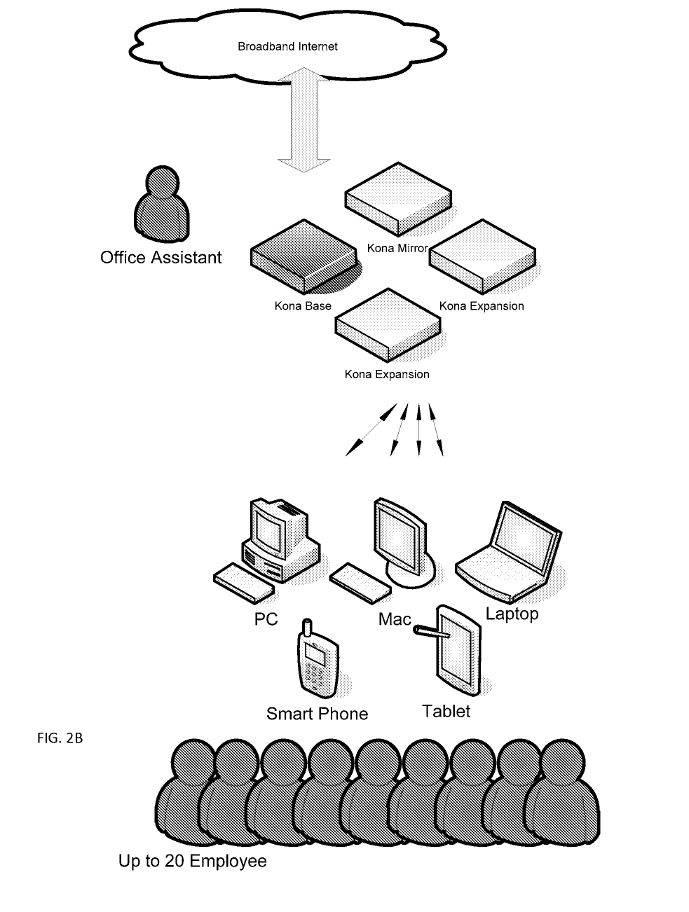

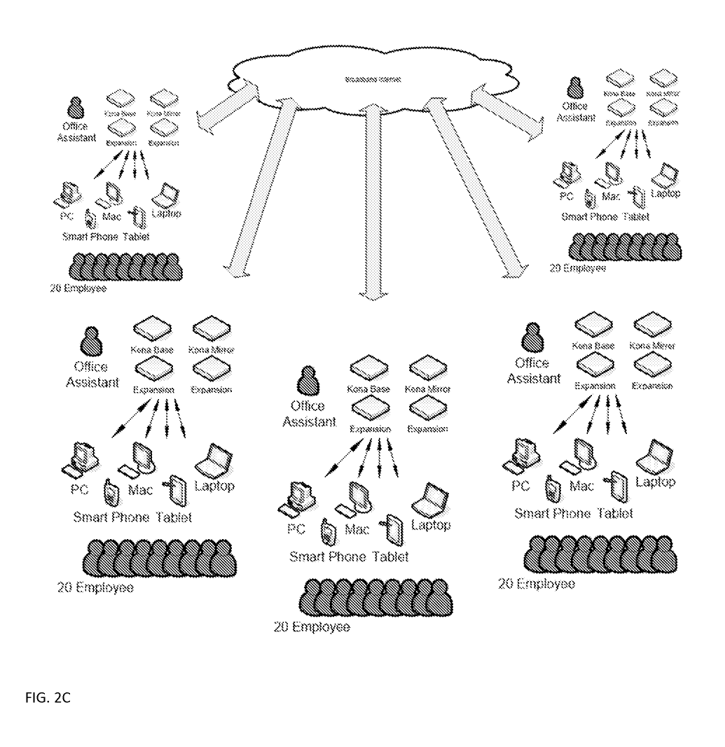

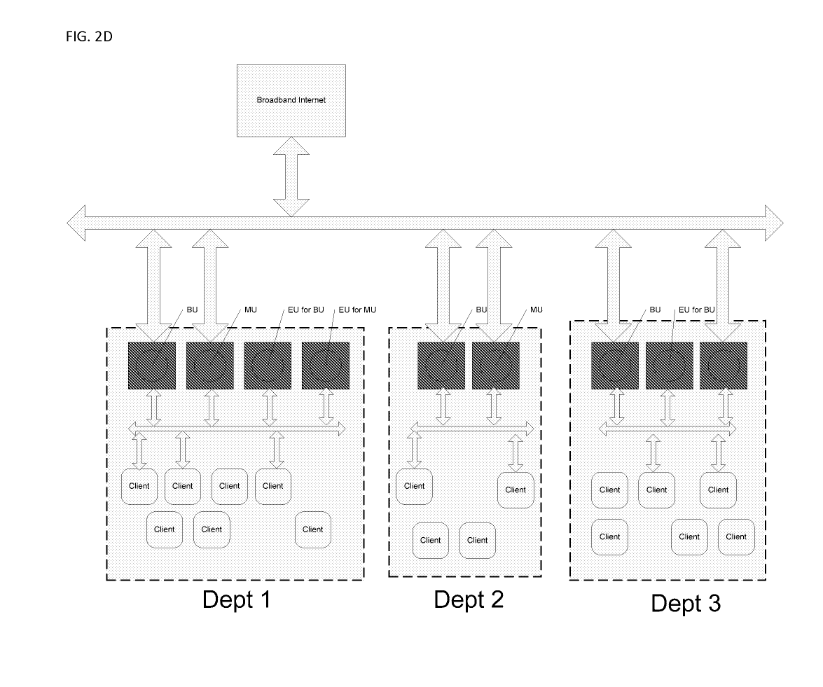

FIGS. 2A-2C illustrate an expandable server that supports server requirements for a one-person business user up to a multi-department company. In FIG. 2A, a single server box (Kona) supports the needs of desktop computer (Macs and PCs), laptops, and mobile devices such as tablets and smart phones. FIG. 2B shows a plurality of boxes used to support the needs of a small business with more than one employee. In this system, one box is used as the server, a second box is used as a back up or mirroring device, and additional boxes are used to distribute the server requirements of the small/medium businesses (SMBs). FIGS. 2C-2D show the use of the server boxes in a multi-department company. In this case, each department deploys one box as the server, a second box as a back up or mirroring device, and additional boxes to distribute the server requirements of the each department.

If the company has multiple departments, each department can deploy the server boxes to fit their own need. In FIG. 2D, each red box is a server box. Some may need mirror server, some may not. Some may need only capacity expansion units. Each department grows at its own pace. Each department's data is separately stored in its own server, and there is no co-mingling of data. The instant server boxes from different departments form a “federation” of servers, where any employee can access any server (with permission) from anywhere. The employee's registered computer or tablet can roam anywhere in the company, and it will be recognized by the WiFi access points of each department. The company has its own “company wide web”.

One embodiment is battery powered, solid state and portable. It is a companion satellite product to the server box in FIG. 2A, serving the employee that is on the road. Yet another embodiment is tailored for the large enterprise space. One main requirement of customers as they migrate to the cloud model is to have their own “server” for company data security reasons. Today there are no cost effective solutions to do this. To provide the customer “data segregation and privacy” at the hardware level with the current server technology, the cost will be prohibitive; the business model would not make sense. Large enterprises (including ISPs) can provide a uniform, fully scalable web server for each client company with full system capability at a very economical price compared to current solutions.

In one embodiment, the server box or unit can connect upstream to a broadband modem or a corporate router. Supports PPPoE or DHCP WAN. All connected computers and tablets can get on to the internet. WiFi Access Point allows wireless clients such as Windows Laptop, MacBook, NetBook, Tablet, smart phone to securely connect to the server unit. An Ethernet port connects wired computers using a suitable network switch. A DHCP server provides DHCP service to computers and tablets. Virtualized storage is provided, and the server unit manages all added storage space. The user sees only one storage space no matter how many expansion units are used. There are no drive letters to deal with, or volumes to mount.

One embodiment provides mirrored server. Instead of just mirrored drives, mirrored servers can be set up. New files written to a master server unit are duplicated within seconds to a complete second server, so users have 2 copies all the time. Mirrored servers test each other's heart beat constantly to make sure each server is healthy. Fail over time is less than 10 seconds and will not affect the office operation.

The system is secure—there is no need to mount to a drive letter. Users access their storage like a website and they can upload and download files to the website. Any computer or tablet that has a browser can access the server unit. Each person uses a log-in name and password. Each person is given a private storage space to store data. Any type of data files can be stored. There is a public space where every computer has access, and can be used for sharing files. Project based storage space can be created for use by 1 or more people. These spaces are only seen by persons that are allowed. When the project is finished, these spaces can be deleted.

The systems of FIGS. 2A-2C apply a distributed server system concept rather than the traditional centralized system concept. In the centralized approach, the products are designed around a large powerful CPU with the peripheral memory and storage attached to it. The problem with this method is that everything needs to pass through a single CPU bottleneck. As expected, traffic to and from the memory and storage devices can become highly congested.

In a distributed approach, less powerful CPUs with their own memory and storage are used. This approach brings down the cost of building these products and lends to a “pay-as-you-go” building block approach. It keeps local tasks local without affecting non-related tasks. In a company example, accounting department's tasks would be processed and kept separately from, say, engineering tasks or marketing tasks.

The distributed approach of FIGS. 2A-2C does not need to use the latest and the greatest CPUs or have the largest memory and storage capacity. The system can use a “good enough” CPU, big enough memory and enough storage to serve a “locale”. The design does not need “bleeding” edge technology allowing the product cost to be low. The server box further incorporates necessary network and server function that a SMB would need (such as WiFi Access, router, UPS, storage, backup) into the hardware design thus further saving money for the business owner. Also incorporated are vital functions that scale with the company's growth to add storage expansion, backup function, mirror configuration or disaster recovery. Customers have a cost-saving all-in-one solution to run their business in a very small package.

In one embodiment, the hardware and software have a unique “single physical package” with multiple personalities. This design provides a unique ability for products that are more acceptable by the SMB. The business owner does not need to understand about different equipment for different purpose. Rather, he or she buys the same box and, through easy-to-use graphical user interface software, configures the box or unit to serve a different function and build a solution that is tailored for the business.

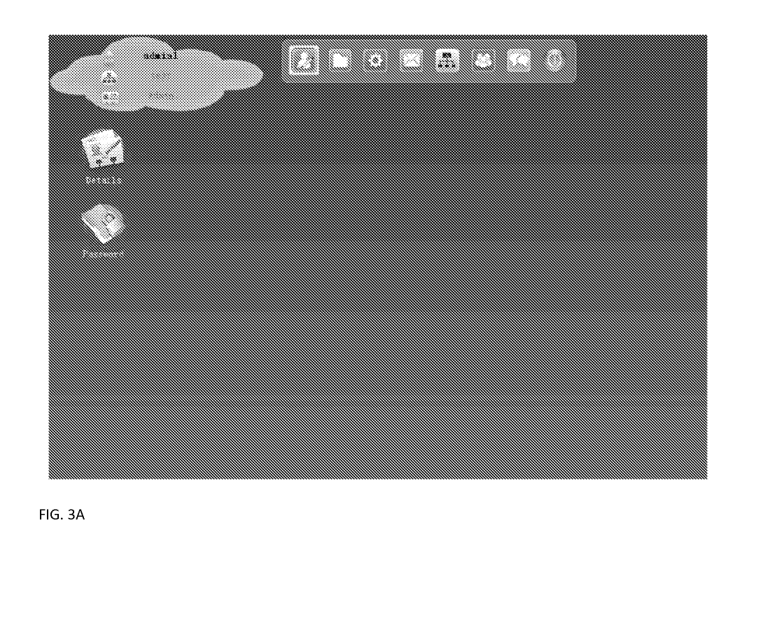

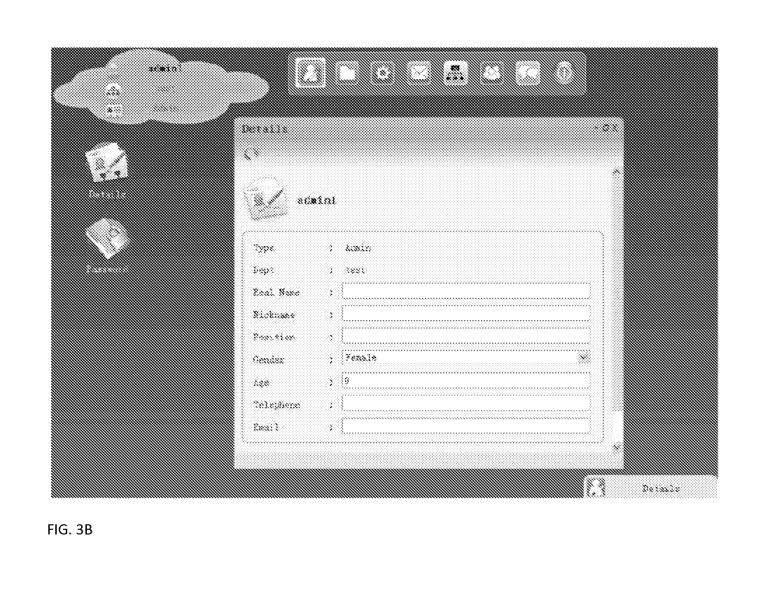

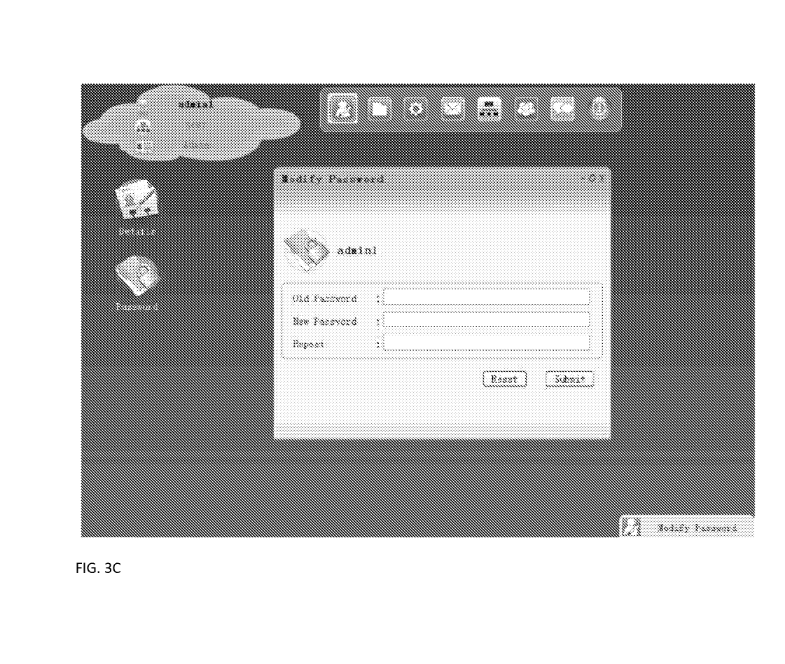

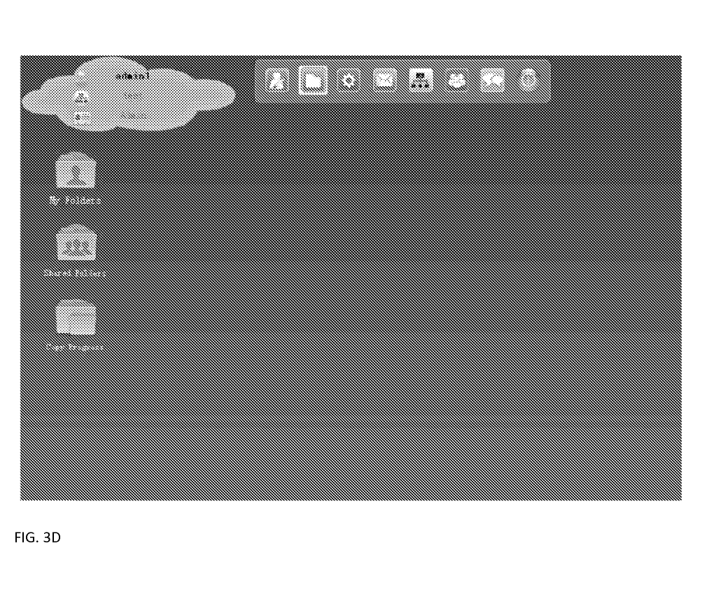

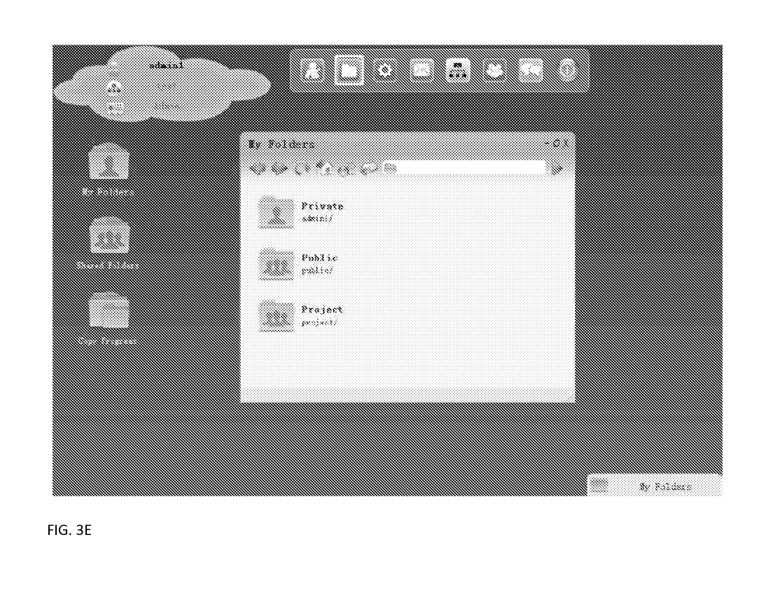

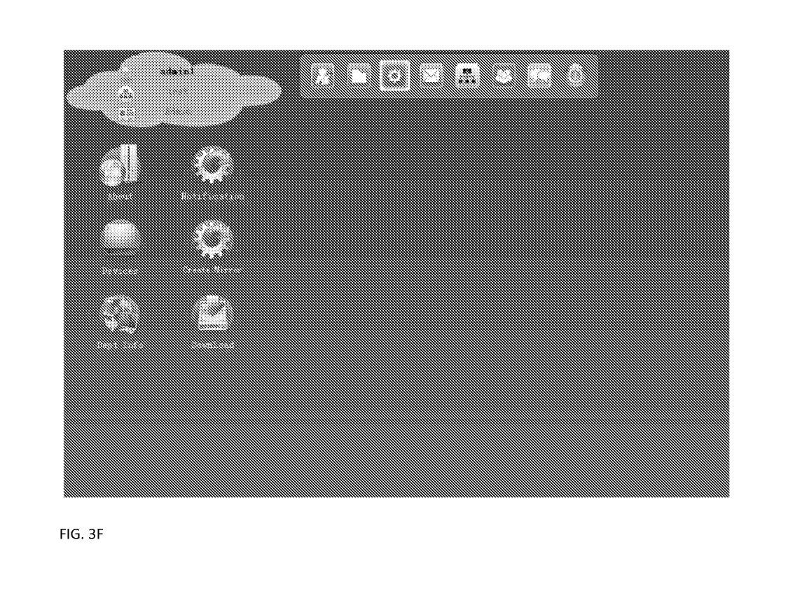

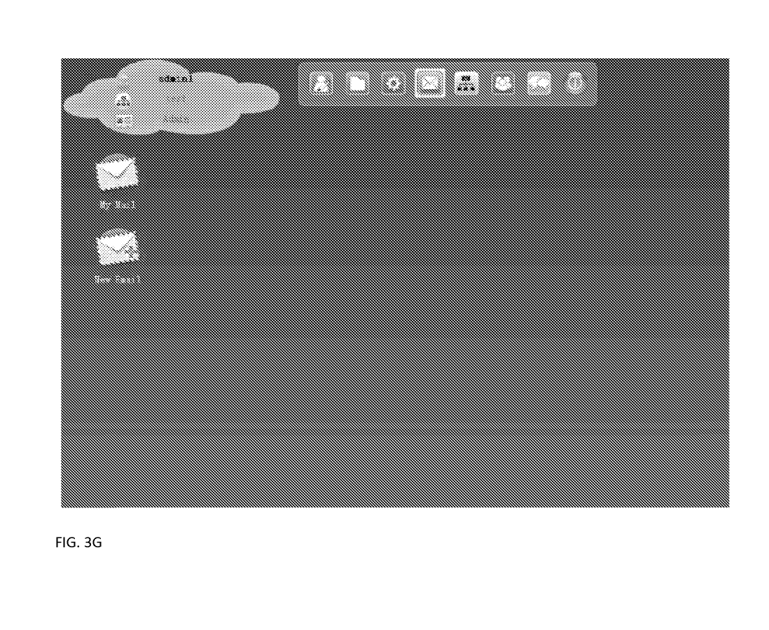

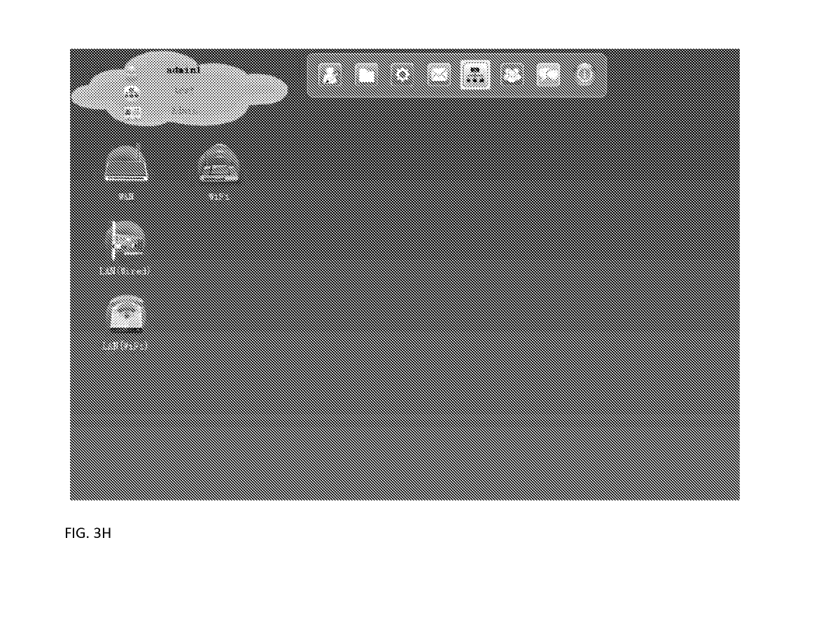

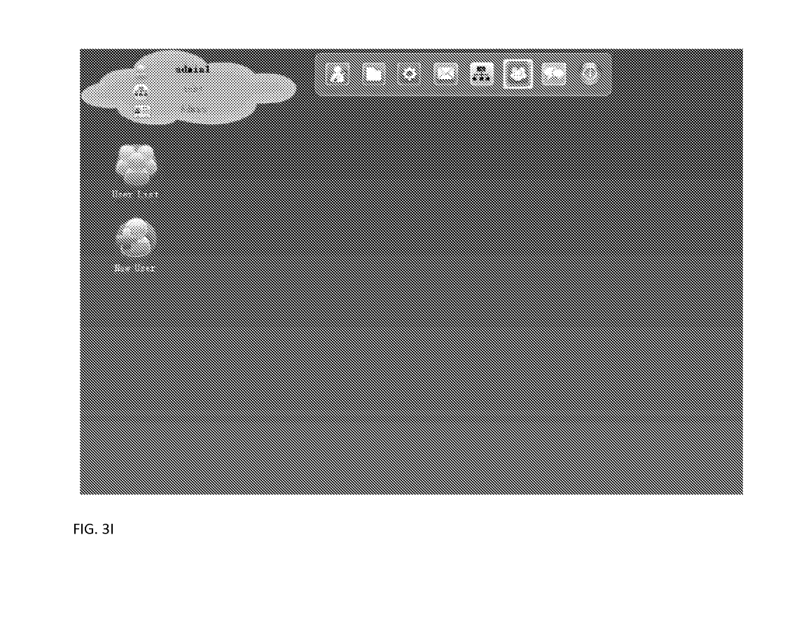

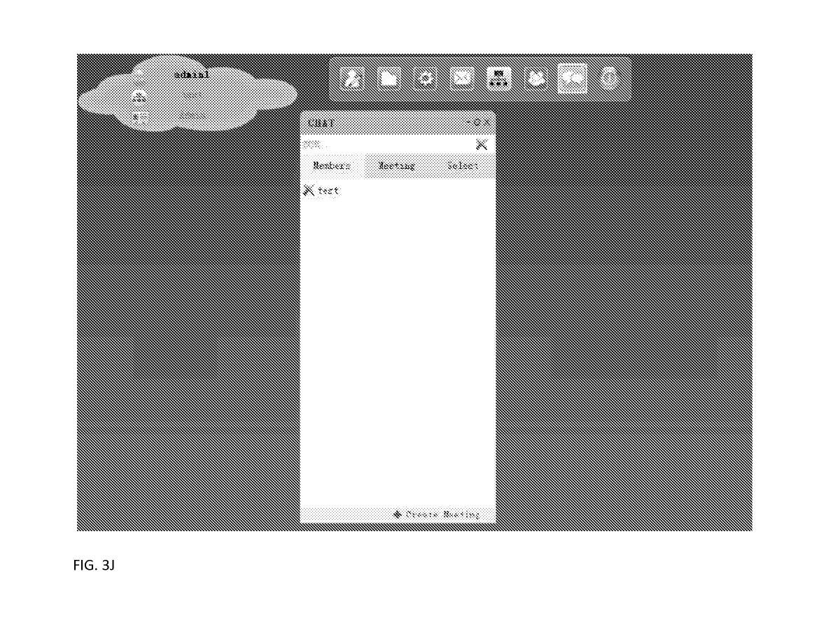

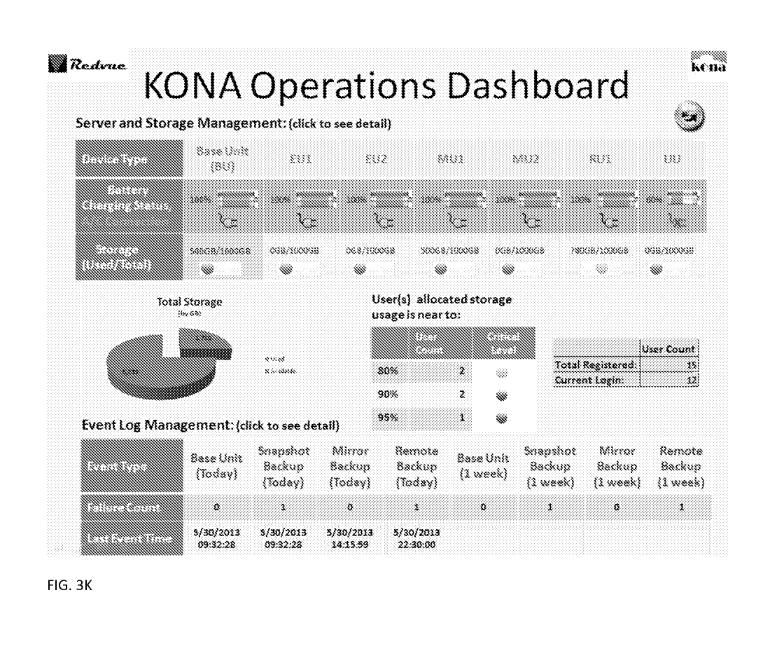

FIGS. 3A-3J show exemplary user interface screens that enable the server unit to flexibly serve small businesses. In FIG. 3A, a main screen is shown. The main screen offers access to functions such as account set up, password, and hardware configuration, among others. FIG. 3B shows an exemplary user interface to collect user account information. Such information includes name, position, gender, age, telephone and email address, among others. FIG. 3C shows a change password user interface. In this screen, the user enters the old password and then enters the new password followed by a confirmation of the new password. FIG. 3D shows an exemplary data storage management function, in this case management of storage folders. FIG. 3E shows exemplary sub-folders within a “My Folders” folder.

FIG. 3F shows an exemplary server setting and configuration screen. In this screen, the user can select devices to be configured, the type of notification to be sent by the server unit. The screen also provides a “Create Mirror” icon that creates a mirrored server. A download icon allows the user to download files or back up information. The download is for firmware download and update via internet. It can be setup to Automatic or Manual by admin). FIG. 3G shows an exemplary email configuration user interface. Through this user interface, the user can create, delete, and manage email accounts.

FIG. 3G shows an exemplary user interface for performing network setting and configuration. Through this user interface, the user can configure the wide area network (WAN), the wired local area network, and wireless local area networks.

FIG. 3H shows an exemplary user management UI where a manager can add, delete, and manage users who are authorized to access the server units. FIG. 3I shows an exemplary user management UI where a manager can add, delete, and manage users who are authorized to access the server units. FIG. 3J shows an exemplary user interface to chat among users of the system.

FIG. 3K shows an exemplary operations dashboard user interface. The dashboard shows the operational status of a plurality of modules or units. In this case, the UPS charge status is shown and available capacity is displayed for the administrator to make decision. User storage allocation is also displayed, and if the user is approaching the maximum allocation, the criticality of the out-of-disk space is graphically indicated. Also, a summary of the event log is shown for management. The exemplary user interface for a Centralized Operations Dashboard enables the administrator to have a firm grasp of the health of the company's server and network system without high cost and lengthy IT support.

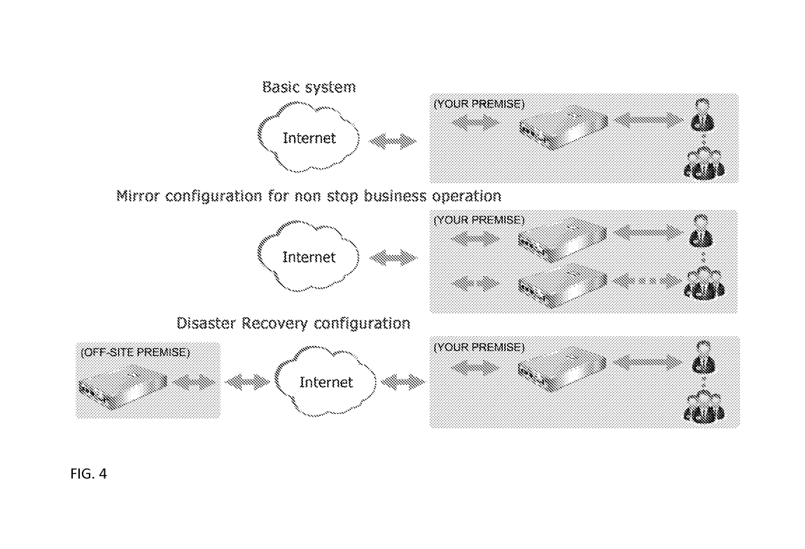

FIG. 4 shows three different configurations from one basic device. In a basic system, one unit is used that provides continuous back up of employee's computers and protects against un-intended erasures or disk crashes or theft of computer. In a second configuration providing a mirror configuration supporting non-stop business operation, two units are used to provide additional protection to the business from equipment failures or mishaps. In the third configuration, one or more units are used locally at the business, and a remote off-site unit is used to provide disaster recover. The third option helps customers quickly recreate business data in case of a natural disaster at the customer's location.

In one embodiment, the expansion unit can be added as follows:

a. Connect new Unassigned Unit (UU) to Base Unit (BU).

b. Launch web browser. Enter Base Unit (BU) IP address to launch User Login page then enter username and password.

c. Click on the “System” icon on the Application Menu Bar then click the Devices icon on the workspace. Kona Base Unit (BU) will start to scan all connected devices and display for viewing and configuration.

d. Click the Unassigned Unit (UU) from the list to launch the configuration page. Select “EU” as configuration option (Options are BU, EU, MU and RU) and click the Confirm to start configuration. System will assign a unique device number (ex. EU1, EU2 . . . ) and allow admin to assign an alias name for easy recognition.

For larger enterprises with multiple base units or bases, the bases can be interconnected via Ethernet port and communicate through the intranet. For example, one BU can be assigned to Finance and one Kona BU can be assigned to Engineering. After interconnected configuration and security setting, they can communicate and share some resources and access Project Folder(s). The business can dedicate one BU as corporate email server to centralize and manage email in one device. The units are quite flexible to architect and configure based on company's business needs.

The mirror base unit is installed in a manner similar to the installation of the UU, but now the user can select the “MU (Mirror Unit)” as configuration option. Under the System module, click the “Create Mirror” icon to initiate the Mirror function. System will recognize the “MU (Mirror Unit)” from previous step and execute the mirror function. The system will scan all files in BU and backup one copy to the MU. Any updated file after the initial mirror backup will be synchronized to MU automatically.

The mirrored servers test each other's heart beat constantly to make sure each server is healthy. Fail over time is less than 10 seconds and will not affect the office operation. As soon as the MU initiated, The MU will start to check BU status by listening heartbeat every 10 seconds (default and configurable) and reading BU status code. The BU has a self-monitoring function to check health of hardware and software. If hardware or software cannot function properly, the system will change its health status to “Take Over” status code. If the MU reads the “Take Over” status code from BU then the operation will failover from BU to MU. Or, if MU is fully operational but cannot ping to get BU's heartbeat for 3 times due the BU hard failure or destruction then MU will take over automatically. There's a configuration option to just notify Admin taking action manually (check actual status then take required action instead of failover automatically).

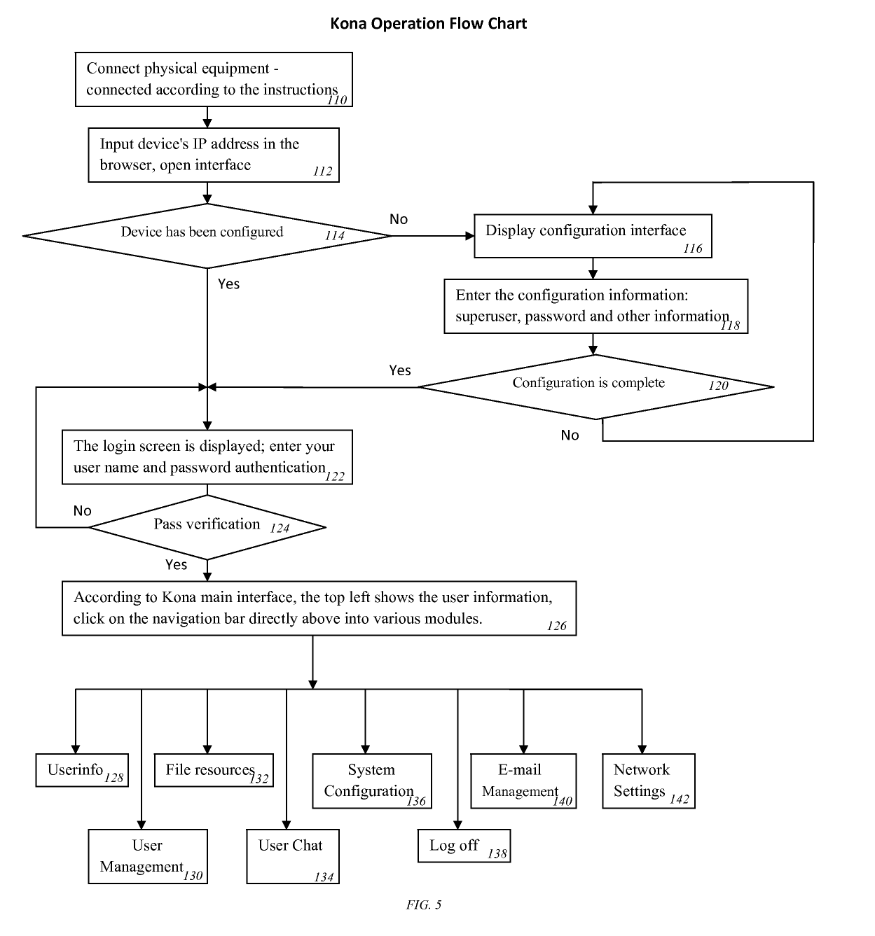

Referring now to FIG. 5, a user connects cables to the server unit (110). Next, the user enters the device's IP address to access the device (112). In one embodiment, the address can be entered into a browser address bar.

Next, the process checks if the device has been configured (114). If no, the process displays a configuration interface (116). The configuration information includes superuser, password, and other information (118). The process then checks for completion of the configuration process (120). If incomplete, the process loops back to 116 to continue the configuration process and otherwise the process proceeds to authenticate a user (122). The process verifies the identity of the user (124). If the password is incorrect, the process loops back to 122 to authenticate the user. If the user passes the authentication test, the process displays a main interface. In the top left portion of the interface, user information is shown and the user can click on the navigation bar to visit the various modules (126). These modules include user information (128), user management (130), file resource (132), user chat (134), system configuration (136), log off (138), email management (140), and network settings (142).

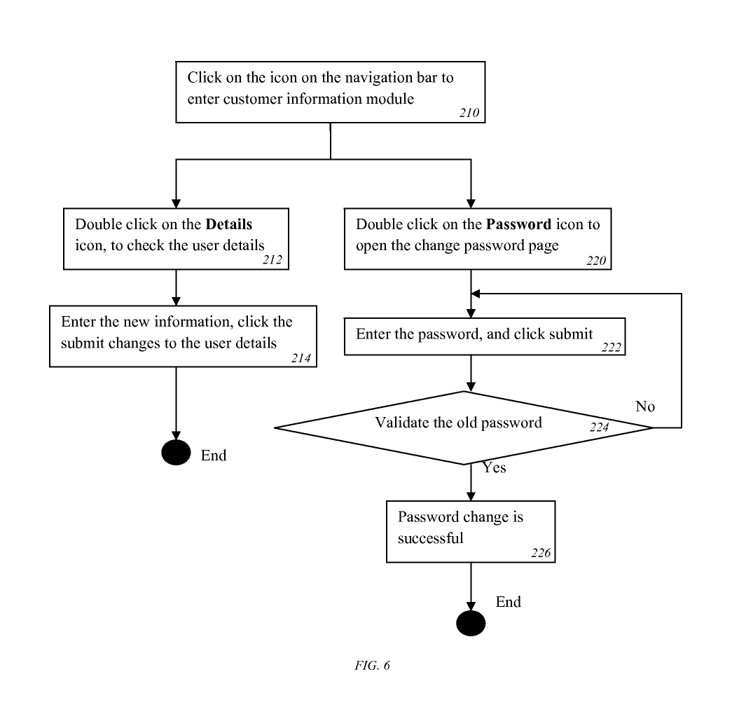

FIG. 6 shows an exemplary user operation process. First, the user clicks on a navigation bar to select a customer information module (210). The user can click on the details icon to check user details (212). The user can then enter new information and click on the submit button to change user details (214).

From 210, the user can select a change password icon to change the password (220). The system will collect the old password, the new password, and a second entry for the new password for confirmation (222). The process validates the password (224) and updates the password (226).

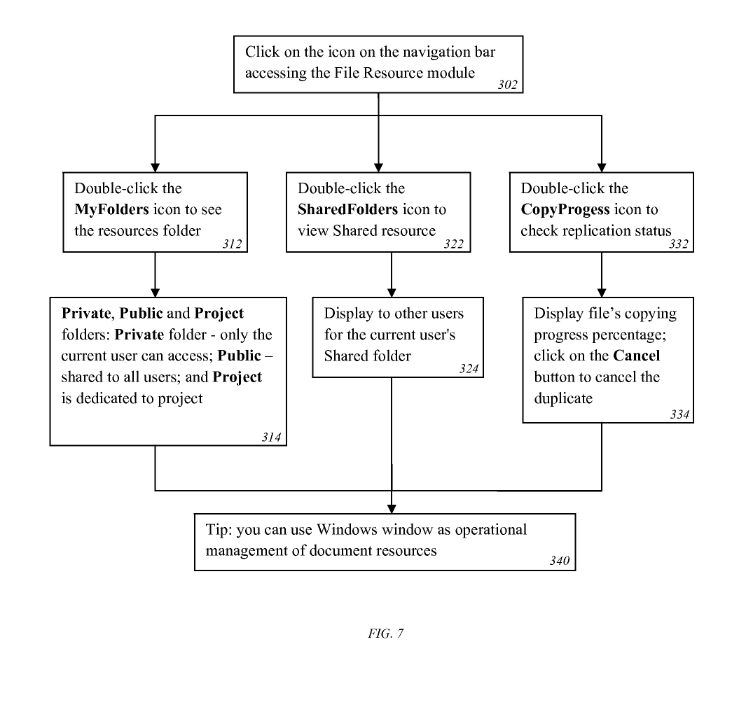

FIG. 7 shows a process supporting file resources. To access the file resources, the user clicks on an icon on the navigation bar to access the file resource module (302). The user can select from a plurality of options. In one option, the user can click on a MyFolder icon to see resources in the MyFolder (312). The user can select private, public and project folders. The private folder only allows the current user to access, the public folder is shared with all users, and the project folder is accessible only to a project team member (314). Alternatively, the user can click on the Shared Folder icon to view shared resources (322). Once selected, the process displays to other users the current user's shared folder (324). Alternatively, from 302, the user can select a Copy Progress icon to check replication status (332). The process displays the file copying progress percentage (334), and the user can click on a cancel button to cancel the copying process. The user can use Window's window to manage the document resources (340).

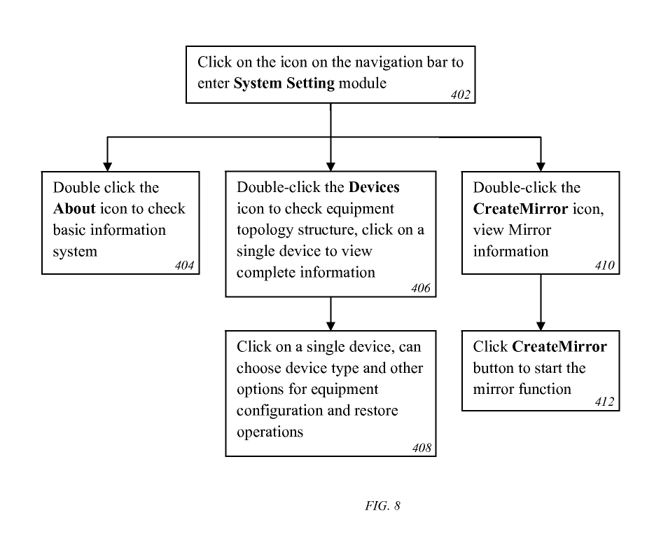

FIG. 8 shows an exemplary system configuration process. The user can click on an icon to enter a system setting module (402). From 402 the user can select options 404, 406 or 410. In 404, the user can view basic information on the system when he or she clicks on the About icon. In 406, the user can view equipment topology when s/he clicks on the Devices icon. After that, the user can click on each dev ice and chose options for equipment configurations and restore operations (408). In 410, the user can click on a Create Mirror icon to create a mirror server and view information on the created mirror server (410). The mirrored system then activates to provide a redundant server for safe computing conditions.

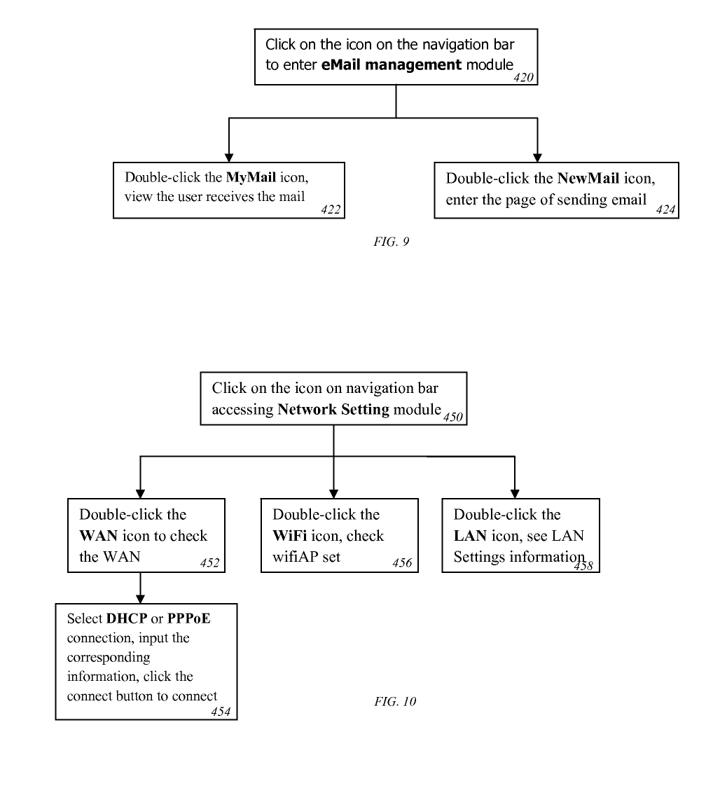

FIG. 9 shows an exemplary email management process. The user clicks on an email management icon on the navigation bar to select email management (420). Once in the module, the user can select a MyMail icon to view mails sent to the user (422). Alternatively, the user can select a New Mail icon to generate a new email so that the user can create and send a message to a remote user (424).

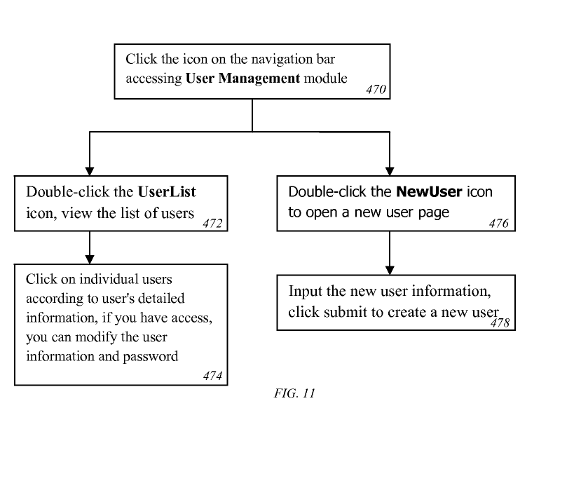

Referring now to FIG. 10, a network settings process is shown. The user clicks on a Network Setting icon to update the network settings (450). The user can then select the WAN icon to check the WAN (452). The user can then select DHCP or PPPoE connection as desired. Once the network information has been entered, the user can click a connect button to connect to the ISP (454). The user can also click on a WiFi button to access wireless network (456). Another option is to click a LAN icon, where the user can see the LAN setting information (458).

FIG. 11 shows a user management process. This module can be reached through a User Management icon on the icon on the navigation bar (470). Once in, the user can click on a User List icon to view a list of users (472). The user can click on each individual user from the detailed list to view the list of users (472). The user can then select a particular user. If access is granted, the user can modify the user information and the password (474). Alternatively, the user can click on the NewUser icon (476) and input the new user information and when done, the user can click to create a new user-site. The user can then input the new information to create a new user (478).

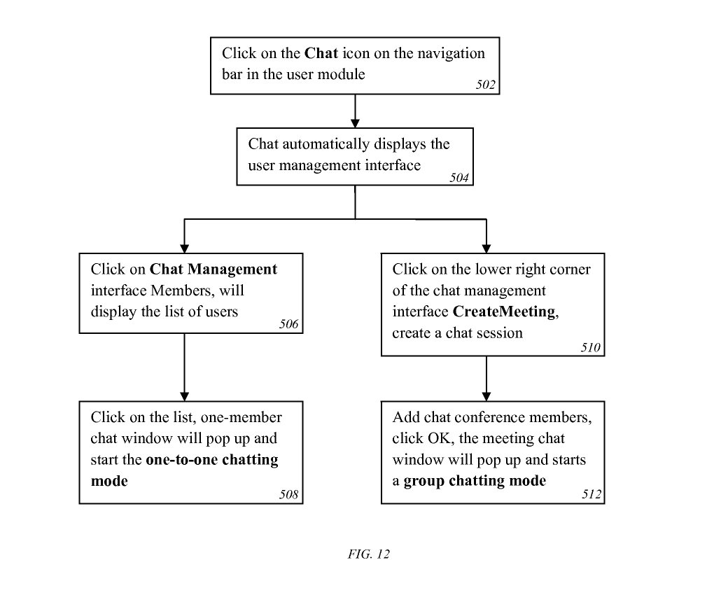

FIG. 12 shows an exemplary process for chatting using the server device. The user can click on a Chat icon to chat with other users on the network (502). The chat window is displayed as part of the user management interface (504). The user can click on a Chat Management icon to display a list of users (506). For one-to-one chatting mode, the user can select from a pop up window to enter chat text (508). From 504, the user can click on a Create Meeting icon to create a group chat session (510). The user can then add conference members and then enter a group chatting mode (512).

In one embodiment, the server platform provides automatic firmware download and upgrade. This function is configurable by an admin to select “Automatic” or “Manual” operation. Thus, the firmware can be automatically downloaded and installed, or the admin can designate manual installation so that the admin can update the firmware in all modules at the same time to prevent or minimize version differences from causing system conflicts.

In another embodiment, the server platform supports automatic storage volume expansion. After adding and configuring the new EUs, the system will automatically check the available storage volume in BU and EUs (EU1, EU2, EU3 . . . ) for data storage. If the unit's available storage volume is low, the system will automatically expand to another EU storage volume. User's folders/files still intact and will not see any difference.

FIG. 13 shows an exemplary user interface for a Centralized Operations Dashboard. BU has a Centralized Operations Dashboard to provide a birds-eye view of the entire landscape in a single view; 100% visibility into system status, early warning alerts, activity logs, event management (correlation of other system/unit events.

The system is easy to operate and supports a do-it-yourself (DIY) IT infrastructure where non-IT personnel can set up and maintain the business IT requirements. A Web based graphical user interface helps the user to easily visualize and manage the system. The business can design the exact configuration for the current business need and change the configuration when business needs change—no need to pre-plan and buy in anticipation of growth. This enables business to grow the system as the business grows. Company information assets are on premise, not in the “cloud”. Communication stays private. With built-in collaboration tools, company internal communications never leave the company. The system automatically preserves company communication and documentation to help with the business' SOX compliance. Data Archiving and Retention is done, and the system off-loads historical data volumes to help organizations automatically preserve company communication and documentation to help with the business' SOX compliance. The system can perform continuous Backup of employees' computers protect against un-intended erasures or disk drive crashes or loss of laptop. The mirror configuration option gives businesses non-stop service, protecting you from business interruptions due to equipment failures or mishaps. The Disaster Recovery configuration option helps customers to quickly recreate your business computers in case of any natural disaster at your business location. The system is economical to own with a low startup cost. High end features are provided, yet priced for small business. The foregoing wealth of features is provided with a low power usage, low noise, petite size that can be placed right on a desk or in a secured location. A cloud interface provides service to computers, tablets and smart phones. The system provides built-in automatic features that require little knowledge of technology for upkeep.

The invention may be implemented in hardware, firmware or software, or a combination of the three. Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The system has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

1. A modular and expandable office system, comprising:
one or more client units;
a base unit (BU) having a predetermined hardware design acting as a base device to provide server operation;
one or more interchangeable modular hardware network devices having the predetermined hardware design to operate in conjunction with the base unit to expand service to the one or more client units, the network device selected from a group consisting of:
a second network unit having the predetermined hardware design coupled to the first unit and serving as a mirror unit under software configuration, wherein the second unit is added as a mirror unit (MU) to back up the first unit as a server;
a third network unit having the predetermined hardware design coupled to the first unit and serving as an expansion unit (EU) under software configuration, wherein the third unit is added as needed to increase client capacity; and
a fourth network unit having the predetermined hardware coupled to the first unit and located at a remote location from the first network unit, and with software configuration, acts as a remote disaster recovery (RU) unit,
wherein each of the BU, MU, EU and RU comprises interchangeable modular hardware with software configurable personalities or roles and each unit includes modules to handle user information, user management, file resource to replicate disk or designate a folder as private or public, user chat, system configuration and equipment topology configuration, email management, and network settings, wherein a graphical user interface (GUI) allows personalization without IT expertise for each unit as either a BU, MU, EU, or an RU, wherein the GUI allows interchangeable modular hardware to be added by a user without information technology (IT) background to perform file resource operation process, system configuration process, email management process, network settings process, user management process and chatting process.

2. The system of claim 1, wherein the client unit is selected from a group consisting of a desktop computer, a mobile phone, and a tablet.

3. The system of claim 1, comprising a web based graphical user interface to manage the system.

4. The system of claim 1, wherein the MU scans files in the BU and backup one copy to the MU and updated files after a first mirror backup is automatically synchronized.

5. The system of claim 1, wherein the BU and the MU tests each other's heart beat to test each server's health.

6. The system of claim 1, wherein BU has a self-monitoring function to check health of hardware and software and setting a take-over status code if hardware or software is not functioning properly.

7. The system of claim 1, wherein the unit has a storage, comprising software providing a user interface with a web-site and communication code to upload and download files to the website

8. The system of claim 7, wherein a computer, mobile phone or tablet accesses files stored in the unit using a browser.

9. The system of claim 1, wherein the storage provides a public space for sharing files and project based storage space for use by one or more people.

10. The system of claim 1, comprising code for automatic firmware download and management of firmware upgrade to all systems within the company network.

11. The system of claim 10, comprising code for an administrator to select automatic or manual operation.

12. The system of claim 1, comprising code for automatic storage volume expansion.

13. The system of claim 12, wherein after adding and configuring the EUs, comprising code for automatically checking available storage volume in BU and EUs for data storage.

14. The system of claim 12, comprising code to determine if the unit's available storage volume is low, comprising code to automatically expand to another EU storage volume.

15. The system of claim 1, comprising a user interface for a Centralized Operations Dashboard.

16. The system of claim 1, wherein the BU has a Centralized Operations Dashboard to provide a birds-eye view of the entire landscape in a single view; 100% visibility into system status, early warning alerts, activity logs, event management (correlation of other system/unit events).

17. The system of claim 1, wherein once an MU mirror backup is established, the BU automatically sends one copy to the MU to keep a mirror copy automatically synchronized.

18. A method to administer an expandable office system, comprising:
installing one or more client units; a base unit (BU) having a predetermined hardware design acting as a base device to provide server operation; one or more network devices having the predetermined hardware design to operate in conjunction with the base unit to expand service to the one or more client units, the network device selected from a group consisting of a second network unit having the predetermined hardware design coupled to the first unit and serving as a mirror unit under software configuration, wherein the second unit is added as a mirror unit (MU) to back up the first unit as a server; a third network unit having the predetermined hardware design coupled to the first unit and serving as an expansion unit (EU) under software configuration, wherein the third unit is added as needed to increase client capacity; and a fourth network unit having the predetermined hardware coupled to the first unit and located at a remote location from the first network unit, and with software configuration, acts as a remote disaster recovery (RU) unit,wherein each of the BU, MU, EU and RU shares a single physical characteristics, and
using a web interface to select software configurable personalities or roles.

19. The method of claim 18, wherein the MU scans files in the BU and backup one copy to the MU and updated files after a first mirror backup is automatically synchronized.

20. The method of claim 18, wherein BU has a self-monitoring function to check health of hardware and software and setting a take-over status code if hardware or software is not functioning properly.
